(19) United States
(12) Patent Application Publication
(10) Pub. No.: US 2018/0281591 A1
(43) Pub. Date: Oct. 4, 2018

(54) SEMI-INDEPENDENT AUTOMATED CLUTCH SYSTEM FOR A MANUAL TRANSMISSION

(71) Applicant: BorgWarner Inc., Auburn Hills, MI (US)

(72) Inventors: Thomas MORGAN, Farmington Hills, MI (US); Dmitriy SEMENOV, Rochester Hills, MI (US); Wesley SHAW, Rochester Hills, MI (US)

(21) Appl. No.: 15/765,729

(22) PCT Filed: Oct. 3, 2016
(86) PCT No.: PCT/US2016/055114

§ 371 Date: Apr. 4, 2018

Related U.S. Application Data
(60) Provisional application No. 62/238,375, filed on Oct. 7, 2015.

(51) Int. Cl. B60K 23/02; B60K 6/387; F15B 13/043; F16D 48/06

(52) U.S. Cl. CPC B60K 23/02; B60K 6/387; F16D 2048/023; F16D 48/066; B60Y 2400/301; F15B 13/0433

(57) ABSTRACT

A product that may include a clutch. A multi-chamber hydraulic unit may define a first chamber, a second chamber and a third chamber, each within the multi-chamber hydraulic unit. A first piston may separate the first chamber from the second chamber. The clutch may open in response to movement of the first piston. A second piston may separate the second chamber from the third chamber. A powered pump and a control valve may be provided wherein one of the second or third chambers may be in interruptible fluid communication with the powered pump through the control valve.

### CROSS-REFERENCE TO RELATED APPLICATIONS

This application claims the benefit of U.S. Provisional Application No. 62/238,375 filed Oct. 7, 2015.

### TECHNICAL FIELD

The field to which the disclosure generally relates includes clutches and more particularly, includes clutches for manual transmissions in vehicles.

### BACKGROUND

A manual transmission may operate with a clutch that may be disengaged or opened to interrupt the torque link between the engine and transmission. The clutch may be opened for gear shifting, vehicle braking and other driving events.

### SUMMARY OF ILLUSTRATIVE VARIATIONS

A product according to a number of illustrative variations may include a clutch. A multi-chamber hydraulic unit may define a first chamber, a second chamber and a third chamber, each within the multi-chamber hydraulic unit. A first piston may separate the first chamber from the second chamber. The clutch may open in response to movement of the first piston. A second piston may separate the second chamber from the third chamber. A powered pump and a control valve may be provided wherein one of the second or third chambers may be in interruptible fluid communication with the powered pump through the control valve.

A number of other illustrative variations may involve a method that may include providing a multi-chamber hydraulic unit. A master cylinder may be connected to the multi-chamber hydraulic unit. A pump may be connected to the multi-chamber hydraulic unit at only one connection. A clutch may be connected to the multi-chamber hydraulic unit. The master cylinder may be operated in a manual mode to actuate the clutch, and the pump may be operated in an automatic mode to operate the clutch.

A number of additional variations may involve a method that may include providing a multi-chamber hydraulic unit. A master cylinder may be connected to the multi-chamber hydraulic unit. The master cylinder may be operated by a clutch pedal. A pump may be connected to the multi-chamber hydraulic unit. A clutch may be connected to the multi-chamber hydraulic unit.

The pump may be operated to maintain the clutch in an open state when the clutch pedal is released.

Other illustrative variations within the scope of the invention will become apparent from the detailed description provided herein. It should be understood that the detailed description and specific examples, while disclosing variations within the scope of the invention, are intended for purposes of illustration only and are not intended to limit the scope of the invention.

### BRIEF DESCRIPTION OF THE DRAWINGS

Select examples of variations within the scope of the invention will become more fully understood from the detailed description and the accompanying drawings, wherein:

FIG. 1 is a schematic diagram of a product according to a number of variations.

FIG. 2 is a schematic diagram of a cylinder assembly of the product of FIG. 1 shown in an unactuated state.

FIG. 3 is a schematic diagram of a cylinder assembly of the product of FIG. 1 shown in a pedal actuated state.

FIG. 4 is a schematic diagram of a cylinder assembly of the product of FIG. 1 shown in a pump actuated state.

FIG. 5 is a schematic diagram of a product according to a number of variations.

FIG. 6 is a schematic diagram of a product according to a number of variations.

FIG. 7 is a chart illustrating of a method according to a number of variations.

FIG. 8 is a chart illustrating of a method according to a number of variations.

### DETAILED DESCRIPTION OF ILLUSTRATIVE VARIATIONS

The following description of the variations is merely illustrative in nature and is in no way intended to limit the scope of the invention, its application, or uses.

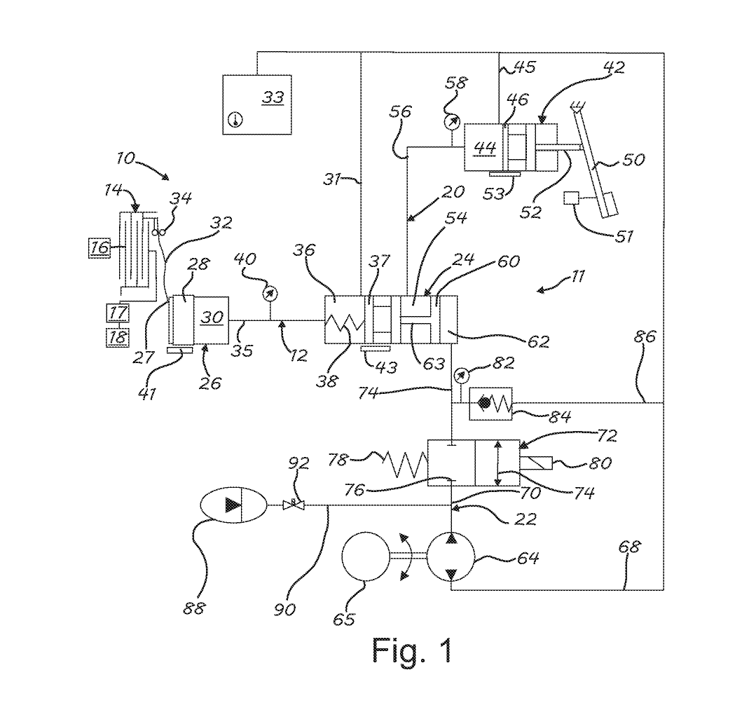

In a number of illustrative variations as illustrated in FIG. 1, a product 10 may involve a clutch system 11 configured to actuate a clutch 14. The clutch 14 may be a selective engagement mechanism between a vehicle's power plant 16 and its driveline 17. The power plant 16 may be an engine or an alternative propulsion unit. The driveline 17 may be connected to one or more wheels 18 to propel the associated vehicle via the power plant 16. The clutch system 11 may include a clutch circuit 12, a clutch pedal circuit 20 and a powered pump circuit 22. The clutch circuit 12 may be responsive to a clutch pedal circuit 20 and a powered pump circuit 22. The clutch circuit 12, the clutch pedal circuit 20 and the powered pump circuit 22 may be separated but may act on each other through a common multi-chamber hydraulic unit 24.

In a number of variations the clutch circuit 12 may include a hydraulic cylinder 26 within which a piston 28 may define a chamber 30. The piston 28 may move within the cylinder 26 in response to a change in fluid pressure within the chamber 30. The cylinder 26 may be a slave cylinder that may be engaged with a diaphragm spring designated as release element 32 of the clutch 14. In other variations the release element 32 may be a lever, clutch fork, or other element to transfer movement from the piston 28 to the clutch 14. The cylinder 26 may be concentric with the release element 32 and may engage its inner fingers 27. The piston 28 may be linked to the clutch 14 through the release element 32 so that when fluid pressure in the chamber 30 may be increased above an actuation level, the chamber 30 may expand and the piston 28 may move the release element 32 to release or open the clutch 14 through a fulcrum 34. When pressure may be reduced in the chamber 30, the spring action of the release element may cause the piston 28 to compress the chamber 30 and close the clutch 14. When the clutch 14 is open, power may not be transferred between the power plant 16 and the driveline 17. When the clutch 14 is closed, power may be transferred between the power plant 16 and the drive line 17. The chamber 30 may be in open fluid communication with a chamber 36 of the multi-chamber hydraulic unit 24 through a conduit 35. The chamber 36 may be defined in the multi-chamber hydraulic unit 24 by a piston 37. The chamber 36 may be connected with a fluid reservoir 33 through a conduit 31 and may draw fluid from, and may return fluid to the reservoir 33. In a number of variations a spring 38 may be positioned in the chamber 36 that may operate in cooperation with the spring 34, and may act to move the piston 37 to expand the chamber 36 fully at lower pressures to return the piston 37. A pressure sensor 40 may be connected in the conduit 35 to monitor and report fluid pressure in the conduit 35. The pressure sensor 40 may be any of the known devices that may operate as a transducer and may generate a signal as a function of the pressure in the conduit 35. The signal may be an electrical signal that may be communicated to a controller such as through a conductor. A position sensor 41 may be positioned in, on, or adjacent to the piston 28 to monitor and report the position of the piston 28. The position sensor 41 may be any of the known types of devices that provide position measurement and may operate on capacitive, conductive, ultrasonic, or other principles. The position sensor 41 may generate a signal that may be an electrical signal that may be communicated to a controller such as through a conductor. In a number of variations a position sensor 43 may be similar to the position sensor 41 and may monitor and report the position of the piston 37. The position sensor 43 may be used in place of, or in addition to, the position sensor 41. The position sensors 41 or 43 may be used to determine the opened/closed state of the clutch 14.

In a number of variations the clutch pedal circuit 20 may include a clutch master cylinder 42 within which a chamber 44 may be defined by a piston 46. The chamber 44 may be connected with a fluid reservoir 33 through a conduit 45 and may draw fluid from, and may return fluid to the reservoir 33.The piston 46 may be connected to a clutch pedal 50 through a link 52 and may be manually actuated by the associated vehicle's driver. A clutch pedal sensor 51 may be connected to the clutch pedal 50 and may monitor and report movement or depression of the clutch pedal 50 from the at rest position. A position sensor 53 may be similar to the position sensor 41 and may monitor and report on the position of the piston 46. The position sensor 53 may be used to determine the extent to which the clutch pedal 50 has been depressed. In a number of variations either the sensor 53 or the sensor 51 may act as both a clutch depression sensor and a position sensor that determines the extent to which the clutch pedal 50 or piston 46 has been actuated The chamber 44 may be open to a chamber 54 of the multi-chamber hydraulic unit 24 through a conduit 56. A pressure sensor 58 may be connected in the conduit 56 to monitor and report fluid pressure in the conduit 56 and may be similar to the pressure sensor 40. The chamber 54 may be defined within the multi-chamber hydraulic unit 24 between the primary piston 37 and a secondary piston 60. The secondary piston 60 may include a rod 63 with a diameter less than the diameter of the piston 60 separating the pistons 37, 60 and providing space for the chamber 54 to contain fluid. The piston 60 may define another chamber 62 within the multi-chamber hydraulic unit 24, separating it from the chamber 54. Depression of the clutch pedal 50 by the driver may cause the piston 46 to compress the chamber 44 thereby increasing fluid pressure therein and in the conduit 56 and in the chamber 54.

In a number of variations the powered pump circuit 22 may include a fluid pump 64 that may be powered by an electric motor 65. The pump 64 may be connected with the chamber 62 of the multi-chamber hydraulic unit 24 through a conduit 70, a control valve 72 and a conduit 74. The pump 64 may be bidirectional in that it may draw fluid from the reservoir 33 through a conduit 68 and may deliver pressurized fluid when operated through the conduit 70, control valve 72, and conduit 74 to the chamber 62, and the pump 64 may draw fluid from the chamber 62 through the conduit 74, the control valve 72, and the conduit 70 and may deliver the fluid to the reservoir 33 through the conduit 68. The pump 64 may be bi-directional such as through reversible rotation of the motor 65 or other known methods. The control valve 72 may be a two position open 74 and closed 76 valve and may be spring 78 returned to a normally closed 76 position. The control valve 72 may be modulated by a solenoid 80, such as through pulse-width modulation or other control to move between the open 74 and closed 76 positions rapidly to modulate pressure in the conduit 74. A pressure sensor 82 may be connected with the conduit 74 to monitor and report fluid pressure in the conduit 74 and may be similar to the pressure sensor 40. A pressure relief valve 84 may be connected to the conduit 74 and may release pressure over a set level to the reservoir 33 through a conduit 86. In a number of variations an accumulator 88, which may be a diaphragm, bladder, piston, or another type, may be connected to the conduit 70 through a conduit 90. A solenoid valve 92 may be provided and may open and close communication of fluid pressure between the accumulator 88 and the conduit 70. For example, the solenoid valve 90 may be opened when the control valve 72 is closed 76 and the pump 64 may be operated to pressurize or charge the accumulator 88. The solenoid valve 90 may be closed to maintain the charge and may be opened when the control valve is open 74, to deliver the charge to more rapidly provide fluid pressure to the chamber 62 as assistance to the pump 64, or as a replacement therefore. In the event of an electrical power interruption, the control valve 72 may be closed 76 by the spring 78 and fluid may be maintained in the chamber 62 thereby maintaining an open clutch 14 if it had been automatically opened by operation of the pump 64. When the pump 64 is not operating, the clutch 14 may be manually actuated by the clutch pedal 50 regardless of whether the control valve 72 is open or closed.

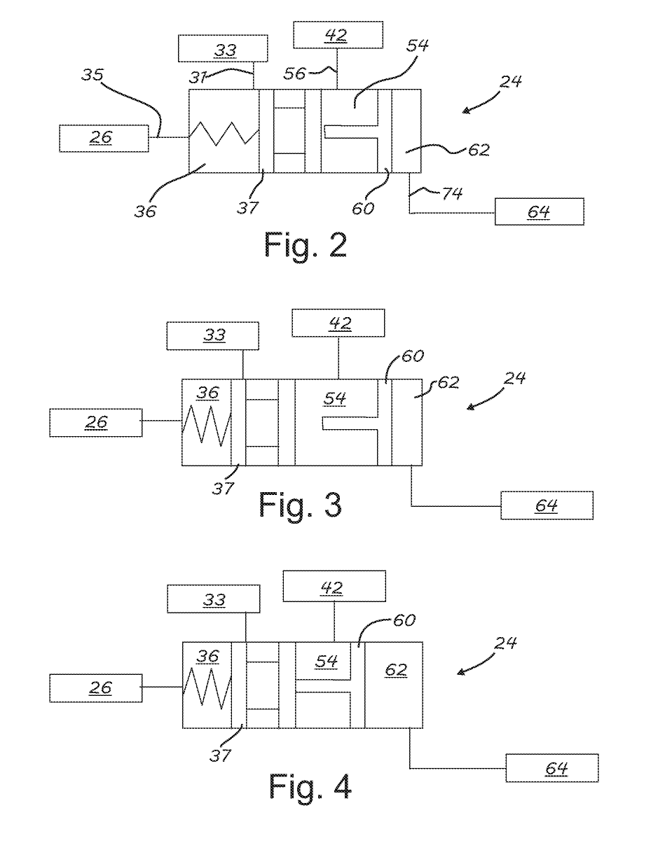

In a number of variations the multi-chamber hydraulic unit 24 may be connected between the clutch circuit 12 at the chamber 36, the clutch pedal circuit 20 at the chamber 54, and the powered pump circuit 22 at the chamber 62. The chambers 36 and 54 may be separated by the primary piston 37, and the chambers 54 and 62 may be separated by the secondary piston 60. Separation of the circuits 12, 20 and 22 may provide for the elimination of a clutch position sensor and clutch position may be inferred from position of the clutch pedal 50 or from the number of rotations of the pump 64. Through the clutch system 11, the clutch 14 may be manually actuated or opened through depression of the clutch pedal 50 by the driver. In this manual mode the control valve 72 may remain closed 76 trapping fluid in the chamber 62. As a result, an increase in pressure in the chamber 54 causes the primary piston 37 to move to compress the fluid in the chamber 36 to move multi-chamber hydraulic unit 24 from an unactuated state as shown in FIG. 2 to a pedal actuated state as shown in FIG. 3. The piston 37 may be separated from the piston 60 in their pedal actuated state positions. The piston 60 may remain unmoved between its unactuated state position in FIG. 2 and its pedal actuated position in FIG. 3. The increased pressure may be communicated from the chamber 36 through the conduit 35, and into the chamber 30. This may cause the piston 28 to move the release element 32 to actuate, or open, the clutch 14. When the driver releases the clutch pedal 50, the spring 38 may move the piston 37 to expand the chamber 36 withdrawing fluid through the conduit 35 and from the chamber 30. The withdrawal of fluid from the chamber 30 may move the piston 28 and the release element 32 to allow the clutch 14 to close or engage.

Through the clutch system 11 the clutch 14 may be automatically actuated or opened through operation of the pump 64 by a controller (not shown). The motor 65 may be operated to rotate the pump in a pressurize direction and the control valve may be moved to open 74 so that the pumped pressure may be delivered to the chamber 62 to move the multi-chamber hydraulic unit 24 form the unactuated state of FIG. 2 to the pump actuated state of FIG. 4. The increased pressure in the chamber 62 may apply force to the piston 60 and through the rod 63 to the piston 37. Both the pistons 37 and 60 may move together to their pump actuated state positions. This may cause a resulting increase in pressure in the chamber 36 and through the conduit 35 in the chamber 30. The pressure increase in chamber 30 may cause the piston 28 to move the release element 32 to actuate or open the clutch 14. The rod 63 may maintain the distance between the piston 60 and the piston 37 so that the size of the chamber 54 remains constant and the fluid therein may simply translate with the pistons 37, 60. Any excess fluid that may exist in the chamber 54, such as when the rod 63 is separated from the piston 37, may be returned to the reservoir 33 through the conduits 56 and 45. Opening actuation of the clutch 14 may be accelerated by opening the solenoid valve 92 to supply fluid pressure from the accumulator 88 to assist the pump 64. The motor 65 may be reversed to operate the pump in a depressurize direction drawing fluid from the chamber 62 through the conduit 74, the control valve 72 and the conduit 70 and returning fluid to the reservoir 33 to allow the clutch to close.

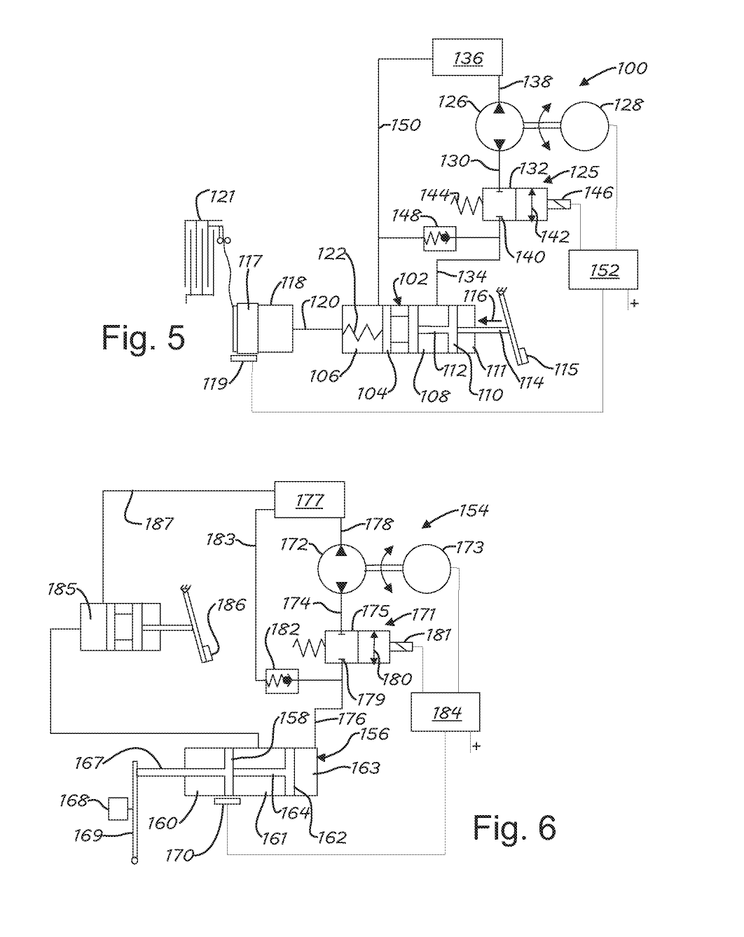

A number of variations as illustrated in FIG. 5 may include a product 100 that may include a multi-chambered hydraulic unit 102. The multi-chambered hydraulic unit 102 may provide combined functions of the multi-chamber hydraulic unit 24 and the master cylinder 24 of FIG. 1. A first piston 104 may separate a first chamber 106 from a second chamber 108 each within the multi-chamber hydraulic unit 102. A second piston 110 may be disposed in the multi-chamber hydraulic unit 102 and in combination with the first piston 104 may define the second chamber 108, and may separate a third chamber 111. The piston 110 may have a rod 112 extending toward the first piston 104 to maintain space for the second chamber 108. A link 114 may extend into the multi-chamber hydraulic unit 102, through the chamber 111, which may be dry, to engage the second piston 110. The link may be connected to a clutch pedal 115 to provide a clutch pedal input 116. The clutch pedal 115 may be mechanically linked to the second piston 110 through the link 114.

In a number of variations the first chamber 106 of the multi-chamber hydraulic unit 102 may be connected with a hydraulic cylinder 118 by a conduit 120 for fluid communication there through. The hydraulic cylinder 118 may be a concentric cylinder similar to the hydraulic cylinder 26 of FIG. 1 to actuate a clutch, or may be a lateral cylinder such as one that may operate with a clutch fork. A position sensor 119 may monitor and report the position of the piston 117 in the hydraulic cylinder 118, which may be used to determine the open/closed state of the associated clutch 121. A spring 122 may be disposed in the first chamber 106 to return the first piston 104 to an unactuated state such as during low pressure in the first chamber 106.

In a number of variations a powered pump circuit 125 may include a fluid pump 126 that may be powered by an electric motor 128. The pump 126 may be connected with the second chamber 108 of the multi-chamber hydraulic unit 102 through a conduit 130, a control valve 132 and a conduit 134. The pump 126 may draw fluid from a reservoir 136 through a conduit 138 and may deliver pressurized fluid when operated through the conduit 130, the control valve 132, and the conduit 134 to the second chamber 108. The pump 126 may be driven in an opposite direction by the motor 128 to draw fluid from the second chamber 108 through the conduit 134, the control valve 132, and the conduit 130, and may deliver the fluid to the reservoir 136 through the conduit 138. The pump 126 may be bi-directional such as through reversible rotation of the motor 128 or other known methods. The control valve 132 may be a two position: open 142 and closed 140, valve and may be spring 144 returned to the closed 140 position. The control valve 132 may be modulated by a solenoid 146, such as through pulse-width modulation or other control to move between the open 142 and closed 140 positions rapidly to modulate pressure in the conduit 134. A pressure relief valve 148 may be connected to the conduit 134 and may release pressure over a set level to the reservoir 136 through a conduit 150. The first chamber 106 may be open to the reservoir 136 when in an unactuated state. The first chamber 106 may be closed to the conduit 150 upon actuation of the multi-chamber hydraulic unit 102, such as after an initial travel of the first piston 104.

Clutch actuation may be manually controlled through the clutch pedal input 116. Force on the rod 114 from the clutch pedal input 115 may apply force on the second piston 110, and through the rod 112 on the first piston 104. Force on the second piston 104 may compress fluid in the first chamber 106 and the resulting pressure may be transmitted through the conduit 120 to the hydraulic cylinder 118 for clutch actuation, which may open the associated clutch. The piston 104 may initially move to cover the conduit 150 to prevent pressure flow to the reservoir 136 during clutch actuation. Removal of the clutch pedal input 116 may allow the piston 117 to return to an unactuated state, and the associated clutch may be engaged. A controller 152 may be connected with the motor 128, solenoid 146, position sensor 119 to control operation of the product 100. Clutch actuation may be automatically controlled by the controller 152 wherein the motor 128 may be operated to pressurize fluid in the conduit 130. The controller 152 may energize the solenoid 146 to shift the control valve 132 to open 142. Pressure may be transmitted through the open control valve 142 through the conduit 134 and into the second chamber 108. Pressure in the second chamber 108 may cause the first piston 104 to compress the first chamber 106 and pressure may be transmitted through the conduit 120 to the hydraulic cylinder 118 to open the associated clutch. To close the clutch, the controller 152 may operate the motor 128 in an opposite direction to draw fluid from the second chamber 108 so that the piston 117 may return to an unactuated position and the associated clutch may be closed.

A number of variations as illustrated in FIG. 6 may include a product 154 that may include a multi-chambered hydraulic unit 156. A first piston 158 may separate a first chamber 160 from a second chamber 161 each within the multi-chamber hydraulic unit 156. A second piston 162 may be disposed in the multi-chamber hydraulic unit 156 and in combination with the first piston 158, may define the second chamber 161. The second piston 162 may have a rod 164 extending toward the first piston 158 to maintain space for the second chamber 164. The second piston 162 may separate a third chamber from the second chamber 161 within the multi-chambered hydraulic unit 156.

In a number of variations the first piston of the multi-chamber hydraulic unit 156 may be engaged with a clutch 168 through a link 167, which may be a rod connected with the first piston 158, and which may extend from the multi-chambered hydraulic unit 156. The link 167 may open the clutch 168, through a lever such as a clutch fork 169. A position sensor 170 may monitor and report the position of the first piston 158, which may be used to determine the open/closed state of the associated clutch 168.

In a number of variations a powered pump circuit 171 may include a fluid pump 172 that may be powered by an electric motor 173. The pump 172 may be connected with the third chamber 163 of the multi-chamber hydraulic unit 156 through a conduit 174, a control valve 175 and another conduit 176. The pump 172 may draw fluid from a reservoir 177 through a conduit 178 and may deliver pressurized fluid when operated through the conduit 174, the control valve 175, and the conduit 176 to the third chamber 163. The pump 172 may be driven in an opposite direction by the motor 173 to draw fluid from the third chamber 163 through the conduit 176, the control valve 175, and the conduit 174, and may deliver the fluid to the reservoir 177 through the conduit 178. The pump 172 may be bi-directional such as through reversible rotation of the motor 173 or other known methods. The control valve 175 may be a two position: closed 179 and open 180, valve. The control valve 175 may be modulated by a solenoid 181, such as through pulse-width modulation or other control to move between the open 180 and closed 179 positions rapidly to modulate pressure in the conduit 175. A pressure relief valve 182 may be connected to the conduit 176 and may release pressure over a set level to the reservoir 177 through a conduit 183.

A controller 184 may be connected with the motor 173, the solenoid 181, and the position sensor 170 to control operation of the product 154. Clutch actuation may be manually controlled through a master cylinder and clutch pedal 186 similar to operation of the product 10 of FIG. 1. The master cylinder chamber 185 may be connected to the second chamber 161 to supply pressure to open the clutch 168. In addition, the master cylinder chamber 185 may be connected to the reservoir 177 through a conduit 187. The conduit 187 may be closed after an initial movement of the master cylinder's piston. Clutch actuation may be automatically controlled by the controller 184 through operation of the pump 172 similar to operation of the pump 64 of the product 10.

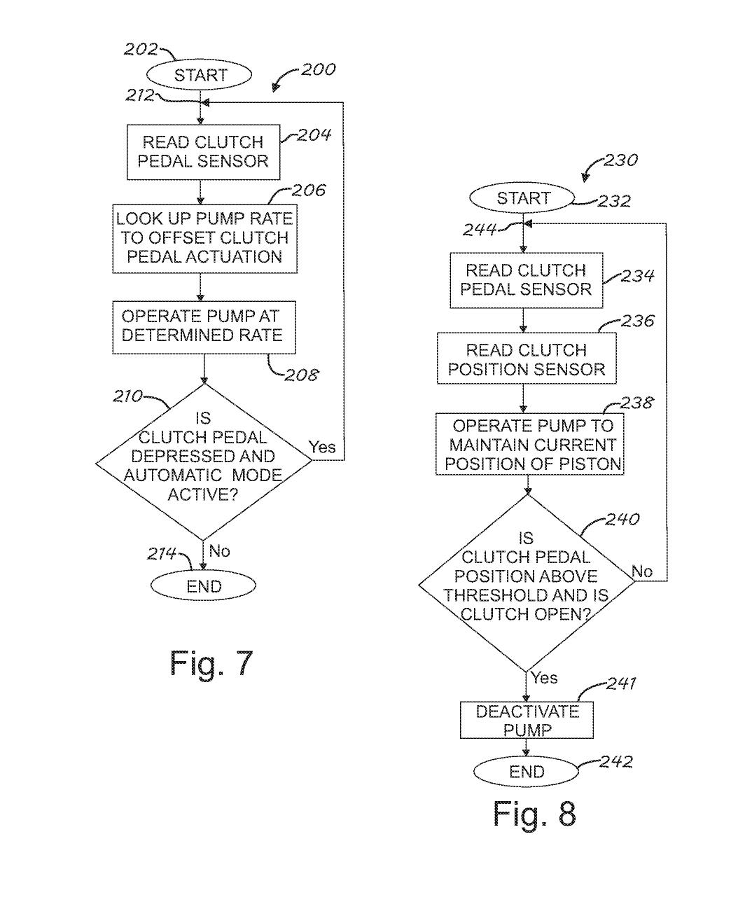

In a number of variations a clutch system may be operated in an override mode as depicted in FIG. 7 as method 200. When the pump 64 is operating to open the clutch 14 by pressurizing the chamber 62, the method 200 may start at step 202 if the clutch pedal 51 is concurrently depressed. The method 200 may proceed to step 204 where the clutch pedal sensor 51 may be read. In a number of variations the pressure sensor 58 may be read as an alternative to, or as a supplement to, the clutch pedal sensor 51. The method 200 may proceed to step 206 where a lookup table may be read to determine a rate of operation of the pump 64 to withdraw fluid from the chamber 62 to offset the pressure increase caused in the chamber 54 by depression of the clutch pedal 50. The method may proceed to step 208 where the pump 64 may be operated at the rate that was determined in step 206. The pump may withdraw fluid from the chamber 62 at a rate equal to the rate at which it is added to the chamber 54, thereby maintaining the position of the piston 37 and as a result the state of the clutch 14. The method may proceed to step 210 where it may be determined if the clutch pedal is still depressed and the automatic actuation of the clutch 14 by the pump 64 is still active. If the determination is positive, the method may return to point 212 and steps 204, 206, 208 and 210 may be repeated. If the determination is negative in that either the clutch pedal 50 has been released or the automatic actuation of the clutch 14 by the pump 64 is inactive, the method 200 may proceed to step 214 and may end. In this way the automatic actuation of the clutch may be maintained at a steady state regardless of a manual input through clutch pedal 50 that may occur during automatic operation.

In a number of variations a clutch system may be operated according to a method 230 as illustrated in FIG. 8. The method 230 may begin at step 232 such as when the clutch pedal 50 may be released in a manner that would conflict with an overriding scenario. For example, the scenario may be a clutch release that could lead to an undesirable load on the associated engine, or the clutch release could be undesirable during a controlled braking event. The method 230 may proceed to step 234 where the clutch pedal position may be determined such as by reading sensor 53 or 51. From step 234, the method 230 may proceed to step 236 where the position of the clutch 14 may be determined such as by reading the position sensor 41 or 43. The method may proceed to step 238 where the pump 64 may be operated to supply fluid pressure to maintain the clutch 14 in its current position, which may be an open state. The pump 64 may be operated according to values determined from a lookup table based on the clutch pedal position determined at step 234. The clutch position sensor 41 or 43 may provide feedback control. The method 230 may proceed to step 240 where a determination may be made as to whether clutch pedal 50 position is above a predetermined threshold and the clutch 14 is open. For example, the predetermined threshold may be full pedal actuation that would result in clutch 14 being open. If it is determined that either the clutch is not depressed enough to achieve the clutch pedal position threshold, or the clutch 14 is not open, the method 230 may return to point 244 and may proceed again from step 234. At step 240, if the clutch pedal position threshold is met and the clutch 14 is open the method 230 may proceed to step 241 where the pump 64 is deactivated and the method 230 may be exited at step 242. The vehicle driver, having depressed the clutch pedal 50 to the clutch pedal position threshold, may manually launch or shift the vehicle using the clutch pedal 50.

The following description of variants is only illustrative of components, elements, acts, products and methods considered to be within the scope of the invention and is not in any way intended to limit such scope by what is specifically disclosed or not expressly set forth. Components, elements, acts, products and methods may be combined and rearranged other than as expressly described herein and still are considered to be within the scope of the invention.

Variation 1 may involve a product that may include a clutch, and a cylinder that may have a first piston connected with the clutch. The clutch may be actuated by the piston in response to an increase in fluid pressure in a chamber of the cylinder. A multi-chamber hydraulic unit may have a second piston separating a pair of chambers within the multi-chamber hydraulic unit. One chamber may be in open fluid communication with the chamber of the cylinder. A third piston may separate another chamber in the multi-chamber hydraulic unit that may be in interruptible fluid communication with a powered pump through a control valve.

Variation 2 may include a product according to variation 1 wherein the powered pump may be in fluid communication with the third chamber through a conduit.

Variation 3 may include the product according to variation 1 or 2 and may include a master cylinder that may have a third piston defining a fourth chamber within the master cylinder A clutch pedal may be connected to the fourth piston The fourth chamber may be connected with the second chamber through a conduit.

Variation 4 may include the product of variation 3 and may include a reservoir that may store fluid and may be in open fluid communication with the first chamber, the fourth chamber, and the powered pump.

Variation 5 may include the product of variation 1 wherein the multi-chamber hydraulic unit may include an unactuated position, a pedal actuated position and a pump actuated position. The first and second pistons may be separated from one another in the pedal actuated position.

Variation 6 may include the product of variation 1 wherein the multi-chamber hydraulic unit may include an unactuated position, a pedal actuated position and a pump actuated position. The second piston may remain unmoved between the unactuated position and the pedal actuated position.

Variation 7 may include the product of variation 1 wherein the multi-chamber hydraulic unit may include an unactuated position, a pedal actuated position and a pump actuated position. The first and second pistons may move together from the unactuated position to the pump actuated position.

Variation 8 may include the product of according to any of variations 1 through 7 and may include an engine and a drive line. The clutch may engage the engine with the drive line.

Variation 9 may include the product of variation 1 and may include a master cylinder that may have a piston that may define a fourth chamber that may be within the master cylinder. A clutch pedal may be connected to the piston. The fourth chamber may be connected with the second chamber through a conduit. The clutch pedal may actuate the clutch regardless of whether the control valve is open or closed.

Variation 10 may include the product of variation 9 and may include a clutch pedal that may be mechanically linked to the second piston.

Variation 11 may include the product according to variation 1 and may include a rod extending from the multi-chambered hydraulic unit that may be engaged with the first piston to move therewith. The clutch may be opened by the rod.

Variation 12 may involve a method that may include providing a multi-chamber hydraulic unit. A master cylinder may be connected to the multi-chamber hydraulic unit. A pump may be connected to the multi-chamber hydraulic unit at only one connection. A clutch may be connected to the multi-chamber hydraulic unit. The master cylinder may be operated in a manual mode to actuate the clutch, and the pump may be operated in an automatic mode to operate the clutch.

Variation 13 may include the method of variation 12 and may include providing a conduit connecting the multi-chamber hydraulic unit with the pump. A valve may be positioned in the conduit.

Variation 14 may include the method of variation 12 and may include operating the pump to withdraw fluid from the multi-chamber hydraulic unit when in the automatic mode and the master cylinder is being operated by depression of a clutch pedal.

Variation 15 may include the method of variation 12 and may include providing a first chamber in the multi-chamber hydraulic unit that may be connected to the clutch. A second chamber may be provided in the multi-chamber hydraulic unit and may be connected to the master cylinder. A third chamber may be provided in the multi-chamber hydraulic unit and may be connected to the pump. A first piston may be provided between the first and the second chambers. A second piston may be provided between the second and the third chambers.

Variation 16 may include the method of variation 12 and may include providing a clutch pedal to actuate the master cylinder. A clutch actuation sensor may be provided. The clutch actuation sensor may be read when in the automatic mode and the clutch pedal is depressed. A pump rate may be determined to offset the clutch pedal depression. The pump may be operated at the determined rate to offset the clutch pedal depression and maintain the clutch actuation.

Variation 17 may involve a method that may include providing a multi-chamber hydraulic unit. A master cylinder may be connected to the multi-chamber hydraulic unit. The master cylinder may be operated by a clutch pedal. A pump may be connected to the multi-chamber hydraulic unit. A clutch may be connected to the multi-chamber hydraulic unit. The pump may be operated to maintain the clutch in an open state when the clutch pedal is released.

Variation 18 may include the method according to variation 17 and may include reading a clutch pedal sensor that measures a position of the clutch pedal. A clutch position sensor may be read that indicates a state of the clutch. Both sensors may be read before operating the pump.

Variation 19 may include the method according to variation 18 and may include determining whether the position of the clutch pedal has met a threshold.

Variation 20 may include the method according to variation 19 and may include deactivating the pump if the position of the clutch pedal has met a threshold and the clutch is in an open state.

The above description of select variations within the scope of the invention is merely illustrative in nature and, thus, variations or variants thereof are not to be regarded as a departure from the spirit and scope of the invention.

What is claimed is:

1. A product comprising a clutch, a multi-chamber hydraulic unit defining a first chamber, a second chamber and a third chamber, each within the multi-chamber hydraulic unit, and a first piston separating the first chamber from a the second, the clutch opening in response to movement of the first piston, a second piston separating the second chamber from the third chamber, and further comprising a powered pump and a control valve wherein one of the second or third chambers is in interruptible fluid communication with the powered pump through the control valve.

2. The product according to claim 1 wherein the powered pump is in fluid communication with the third chamber through a conduit.

3. The product according to claim 1 further comprising a master cylinder having a third piston defining a fourth chamber within the master cylinder, a clutch pedal connected to the third piston, and the fourth chamber connected with the second chamber through a conduit.

4. The product according to claim 3 further comprising a reservoir storing fluid and in open fluid communication with the first chamber, the fourth chamber, and the powered pump.

5. The product according to claim 1 wherein the multi-chamber hydraulic unit includes an unactuated position, a pedal actuated position and a pump actuated position, wherein the first and second pistons are separated in the pedal actuated position.

6. The product according to claim 1 wherein the multi-chamber hydraulic unit includes an unactuated position, a pedal actuated position and a pump actuated position, wherein the second piston remains unmoved between the unactuated position and the pedal actuated position.

7. The product according to claim 1 wherein the multi-chamber hydraulic unit includes an unactuated position, a pedal actuated position and a pump actuated position, wherein the first and second pistons move together from the unactuated position to the pump actuated position.

8. The product according to claim 1 further comprising an engine and a drive line, the clutch engaging the engine with the drive line.

9. The product according to claim 1 further comprising a master cylinder having a piston defining a fourth chamber within the master cylinder, a clutch pedal connected to the piston, the fourth chamber connected with the second chamber through a conduit, wherein the clutch pedal actuates the clutch regardless of whether the control valve is open or closed.

10. The product according to claim 1 further comprising a clutch pedal, wherein the clutch pedal is mechanically linked to the second piston.

11. The product according to claim 1 further comprising a rod extending from the multi-chambered hydraulic unit, the rod engaged with the first piston to move therewith, the clutch opened by the rod.

12. A method comprising providing a multi-chamber hydraulic unit, connecting a master cylinder to the multi-chamber hydraulic unit, connecting a pump to the multi-chamber hydraulic unit at only one connection, connecting a clutch to the multi-chamber hydraulic unit, operating the master cylinder in a manual mode to actuate the clutch, and operating the pump in an automatic mode to operate the clutch.

13. The method according to claim 12 further comprising providing a conduit connecting the multi-chamber hydraulic unit with the pump and positioning a valve in the conduit.

14. The method according to claim 12 further comprising operating the pump to withdraw fluid from the multi-chamber hydraulic unit when in the automatic mode and the master cylinder is operated by depression of a clutch pedal.

15. The method according to claim 12 further comprising providing a first chamber in the multi-chamber hydraulic unit connected to the clutch, providing a second chamber in the multi-chamber hydraulic unit connected to the master cylinder, providing a third chamber in the multi-chamber hydraulic unit connected to the pump, providing a first piston between the first and the second chambers, and providing a second piston between the second and the third chambers.

16. The method according to claim 12 further comprising providing a clutch pedal to actuate the master cylinder, providing a clutch actuation sensor, reading the clutch actuation sensor when in the automatic mode and the clutch pedal is depressed, determining a pump rate to offset the clutch pedal depression, and operating the pump at the determined rate to offset the clutch pedal depression and maintain the clutch actuation.

17. A method comprising providing a multi-chamber hydraulic unit, connecting a master cylinder to the multi-chamber hydraulic unit, the master cylinder operated by a clutch pedal, connecting a pump to the multi-chamber hydraulic unit, connecting a clutch to the multi-chamber hydraulic unit, operating the pump to maintain the clutch in an open state when the clutch pedal is released.

18. The method according to claim 17 further comprising reading a clutch pedal sensor that measures a position of the clutch pedal, and reading a clutch position sensor that indicates a state of the clutch, both before operating the pump.

19. The method according to claim 18 further comprising determining whether the position of the clutch pedal has met a threshold.

20. The method according to claim 19 further comprising deactivating the pump if the position of the clutch pedal has met a threshold and the clutch is in an open state.
